(19) United States
(12) Patent Application Publication
(10) Pub. No.: US 2015/0017948 A1
(43) Pub. Date: Jan. 15, 2015

(54) METHOD AND SYSTEM FOR IN-APPLICATION LOCKING OF MOBILE DEVICES

(71) Applicant: NVIDIA Corporation, Santa Clara, CA (US)

(72) Inventor: Wayne BRENCKLE, San Jose, CA (US)

(21) Appl. No.: 13/941,288

(22) Filed: Jul. 12, 2013

(51) Int. Cl. G06F 21/50

(52) U.S. Cl. CPC G06F 21/50
USPC 455/411

(57) ABSTRACT

Embodiments of the present invention are capable of detecting a command issued by the user to lock a mobile device from receiving user input provided by input devices coupled to the mobile device, as well as the native buttons of the device itself, while an application executes. Provided the command is confirmed by the user, embodiments may proceed to intercept signals transmitted from input devices coupled to the mobile device and as well as from the native buttons of the device for the duration of the device's locked state. Additionally, embodiments of the present invention can provide users with visual notification of the device's current locked state. Furthermore, embodiments may operable remove the mobile device from a locked state in a manner that enables the application to resume receiving user input in a standard operational manner in response to detecting a subsequent unlock command issued by the user.

### FIELD OF THE INVENTION

Embodiments of the present invention are generally related to the field of devices capable of executing applications and displaying video content in a mobile environment.

### BACKGROUND OF THE INVENTION

Conventional mobile devices offer users a variety of different ways to interact with applications executed on such devices, such as through touch sensitive display screens or through various buttons located on a device. However, when using certain applications on these devices, users may unintentionally interfere with their execution. For instance, a user may inadvertently make contact with a touch sensitive display screen which may cause an application, receptive to such contact, to perform a corresponding inadvertent action in response. In some cases, the corresponding action performed by the application may lead to the user's session being interrupted or even brought to an abrupt end.

Conventional methods of addressing these issues generally fail to consider individuals who may not possess the technical competency required to handle such devices. As such, using conventional mobile devices may prove to be especially cumbersome for inexperienced users, such as young children. Accordingly, the inefficiencies of conventional methods may result in a higher frequency of inadvertent commands being received by applications and may ultimately lead to users being frustrated at not being able to properly use desired applications.

### SUMMARY OF THE INVENTION

What is needed is a solution that minimizes the frequency of inadvertent commands being received by an application executed on a mobile device in a manner that allows users to interact with the device much more freely as the application is being executed. Embodiments of the present invention are capable of detecting a command issued by the user to lock a mobile device from receiving user input provided by input devices coupled to the mobile device, as well as the native buttons of the device itself, while an application executes. Provided the command is confirmed by the user, embodiments may proceed to intercept or ignore signals transmitted from input devices coupled to the mobile device and as well as from the native buttons of the device for the duration of the device's locked state. Additionally, embodiments of the present invention can provide users with visual notification of the device's current locked state. Furthermore, embodiments may be operable remove the mobile device from a locked state in a manner that enables the application to resume receiving user input in a standard operational manner in response to detecting a subsequent unlock command issued by the user.

More specifically, in one embodiment, the present invention is implemented as a method of interacting with a mobile device. The method includes detecting an initial command from a user, in which the initial command is issued using programmable buttons native to the mobile device. In one embodiment, the detecting further includes prompting the user using a visual display prompt to confirm the initial command. In one embodiment, the programmable buttons are capacitive touch buttons. In one embodiment, the programmable buttons are mechanical buttons. In one embodiment, the programmable buttons comprise: a home button, a back button and a menu button.

The method also includes intercepting input device signals transmitted from an input device coupled to the mobile device during execution of an application responsive to the initial command, in which the intercepting disables receipt of the input device signals to applications executing on the mobile device. In one embodiment, the intercepting further comprises intercepting button input signals transmitted from the programmable buttons. In one embodiment, the input device is a touch sensitive input device. Additionally, the method includes enabling receipt of the input device signals by the applications responsive to detecting a subsequent command from the user, in which the subsequent command is issued using the programmable buttons.

In one embodiment, the present invention is implemented as a system for locking a mobile device. The system includes a detection module operable to detect an initial command from a user, in which the initial command is issued using programmable buttons of the mobile device, in which the detection module is operable to detect a subsequent command from the user, in which the subsequent command is issued using the programmable buttons. In one embodiment, the initial command and the subsequent command are invoked by a same user interaction. In one embodiment, the programmable buttons are capacitive touch buttons. In one embodiment, the programmable buttons are mechanical buttons.

The system also includes a locking module operable to intercept input device signals transmitted from an input device coupled to the mobile device during execution of an application responsive to the initial command, in which the locking module is operable to enable receipt of the input device signals responsive to a detection of the subsequent command. In one embodiment, the locking module is further operable to intercept button input signals transmitted from the programmable buttons. In one embodiment, the locking module is further operable to suspend receipt of the input device signals by applications configured to accept the input device signals. Additionally, the system also includes a sensor operable to receive touch input from a user. Furthermore, the system includes an electronic visual display source coupled adjacent to the sensor. In one embodiment, the system includes a prompting module operable to prompt the user using a visual display prompt to confirm the initial command.

In one embodiment, the present invention is implemented as a method of locking a mobile device. The method includes detecting an initial command from a user, in which the initial command is issued using programmable buttons native to the mobile device. In one embodiment, the detecting further includes prompting the user using a visual display prompt to confirm the initial command. In one embodiment, the programmable buttons are capacitive touch buttons. In one embodiment, the programmable buttons are mechanical buttons in which the programmable buttons comprise: a home button, a back button and a menu button. In one embodiment, the initial command and the subsequent command are invoked by a same user interaction.

The method also includes intercepting and suspending input device signals transmitted from an input device coupled to the mobile device during execution of an application responsive to the initial command. In one embodiment, the intercepting and suspending further includes intercepting and suspending button input signals transmitted from the programmable buttons. Additionally, the method includes enabling receipt of the input device signals responsive to detecting a subsequent command from the user, in which the subsequent command is issued using the programmable buttons.

### BRIEF DESCRIPTION OF THE DRAWINGS

FIG. 1 is a block diagram depicting an exemplary electronic device in accordance with embodiments of the present invention.

FIG. 2A is a flowchart that depicts exemplary input locking operations in accordance with embodiments of the present invention.

FIG. 2B is a flowchart that depicts exemplary input unlocking operations in accordance with embodiments of the present invention.

FIG. 3 is an illustration that depicts an exemplary input lock command detection process with on-screen menu in accordance with embodiments of the present invention.

FIG. 4A is an illustration that depicts the functional state of a device placed within an inputs locked state in accordance with embodiments of the present invention.

FIG. 4B is another illustration that depicts the functional state of a device placed within an inputs locked state in accordance with embodiments of the present invention.

FIG. 5 is an illustration that depicts an exemplary input unlock command detection process in accordance with embodiments of the present invention.

FIG. 6 is an illustration that depicts the functional state of a device removed from an inputs locked state in accordance with embodiments of the present invention.

FIG. 7A is an illustration that depicts the functional state of a device capable of enabling an application requiring continuous user input to override an inputs locked state in accordance with embodiments of the present invention.

FIG. 7B is an illustration that depicts an exemplary menu capable of enabling certain system functions and/or applications to override an inputs locked state in accordance with embodiments of the present invention.

FIG. 7C is an illustration that depicts the functional state of a device capable of enabling an certain system functions to override an inputs locked state based on determinations made by a user in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

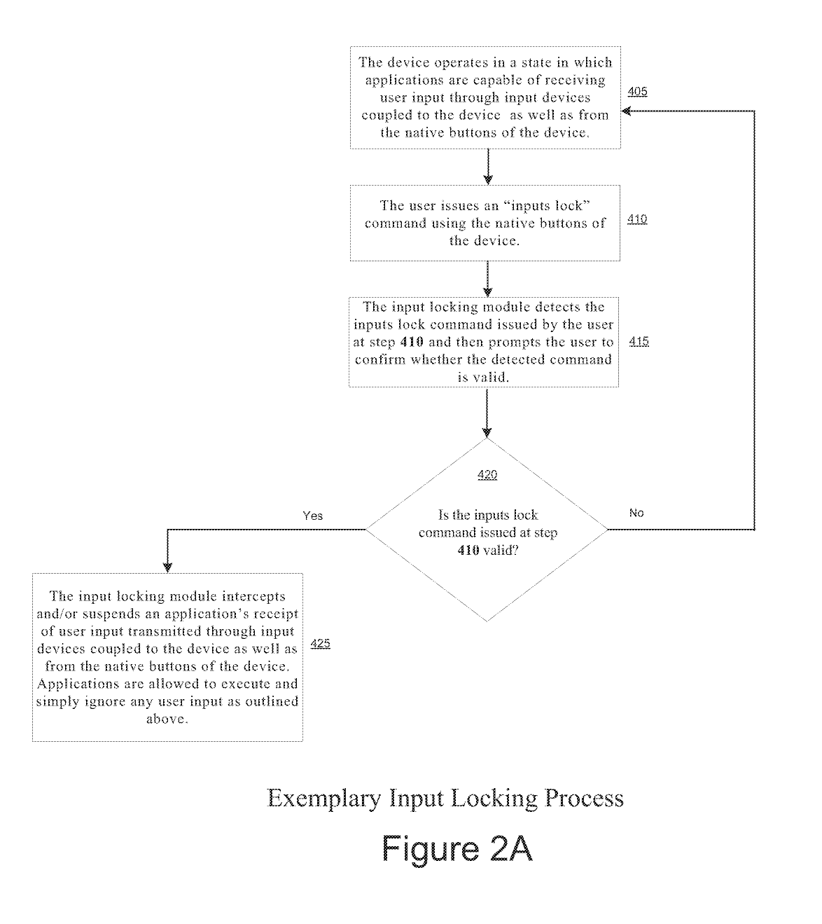

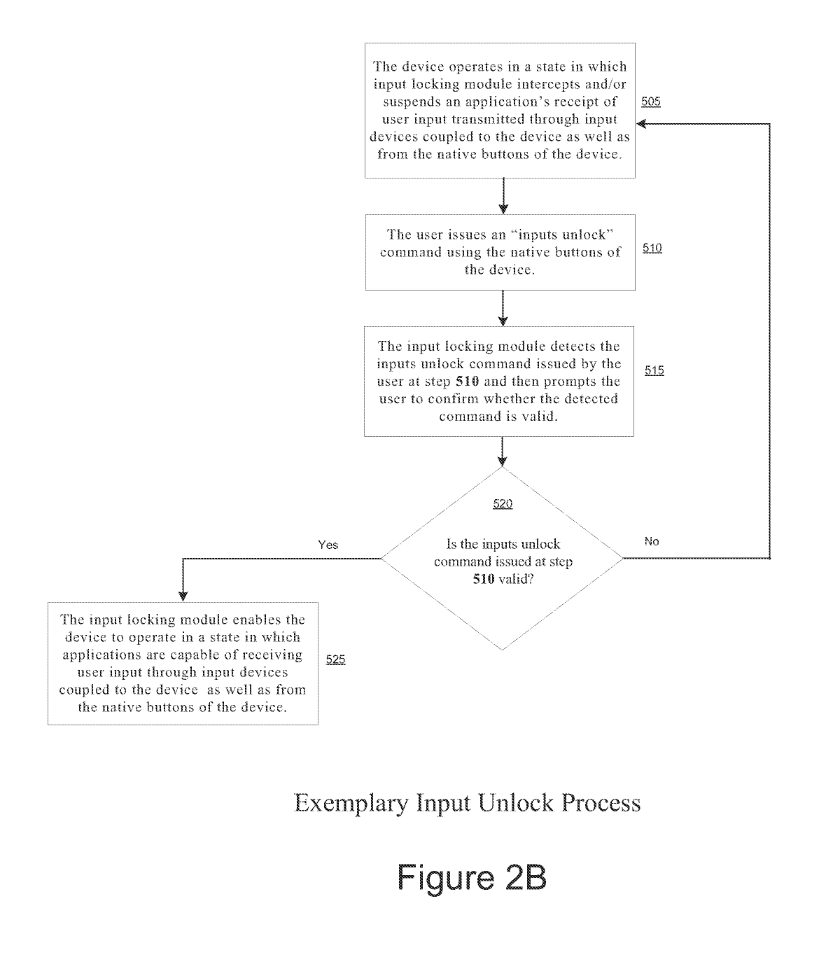

Portions of the detailed description that follow are presented and discussed in terms of a process. Although operations and sequencing thereof are disclosed in a figure herein (e.g., FIG. 2A, 2B) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, device, and the like are intended to refer to a computer-related entity, specifically, either hardware, firmware, a combination of hardware and software, software, or software in execution. For example, a module can be, but is not limited to being, a process running on a processor, an integrated circuit, an object, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

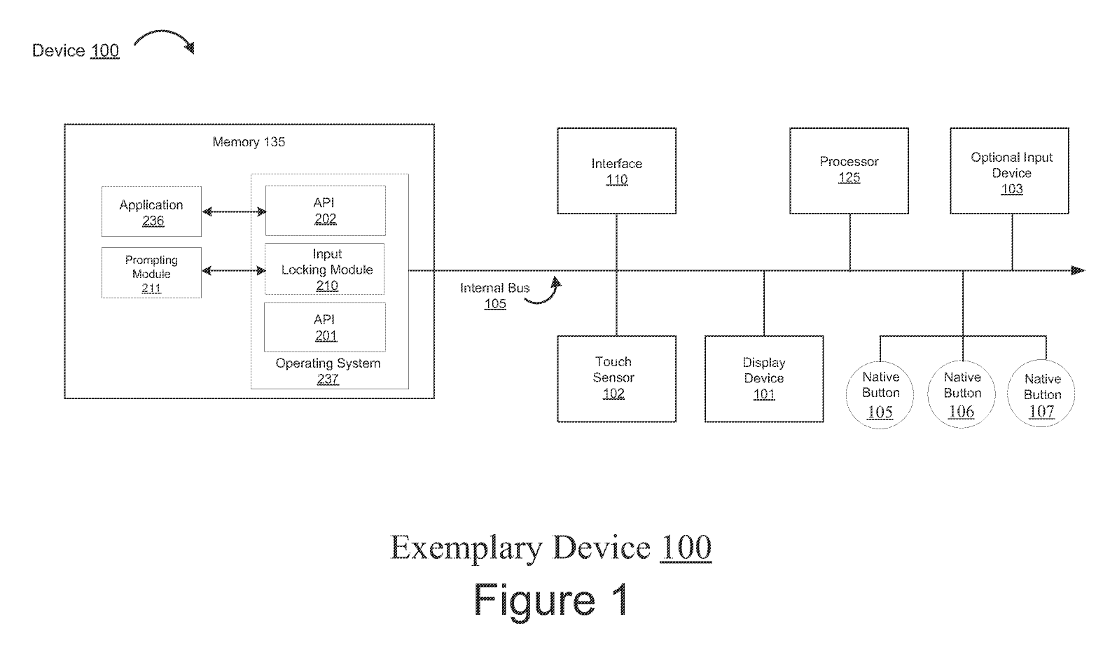

FIG. 1 is a block level diagram of an exemplary device (e.g., device 100) capable of performing in-application locking operations in accordance with embodiments of the present invention. Device 100 may comprise input locking module 210, prompting module 211, touch sensor 102, display device 101, optional input device 103, interface 110, processor 125, processor 110, operating system 237, main memory 135 as well as native buttons 105, 106 and 107. It should be appreciated that embodiments of the present invention are not limited to the number of native buttons depicted in FIG. 1 and may support implementations that include the use of fewer or more native buttons. Device 100 can be implemented as, for example, a portable electronic device (e.g., cellular phone, entertainment device, handheld device) and the like. Furthermore, components of device 100 may be coupled via internal communications bus (e.g., internal bus 105) and may receive/transmit data for further processing over such internal communications bus.

As illustrated by the embodiment depicted in FIG. 1, input locking module 210 may operate within conventional operating system (e.g., operating system 237) of device 100. In one embodiment, input locking module 210 may be loaded and unloaded into partitions within the virtual memory space of operating system 237 (e.g., kernel level). As such, input locking module 210 may include the functionality to communicate inputs received from one or more input devices coupled to device 100 at the hardware level (e.g., touch sensor 102, optional input device 103, etc.) to applications residing at the software level (e.g., application 236). Although input locking module 210 is depicted as part of operating system 237 in FIG. 1, it will also be appreciated that locking module 210 may be separate from operating system 237.

Embodiments of the present invention may include the functionality to communicate inputs received from input devices coupled to device 100 to applications residing in memory using application programming interface (“API”) software layers. For instance, with reference to the embodiment depicted in FIG. 1, API 202 may provide an interface between input locking module 210 and applications residing in memory (e.g., application 236). As such, applications residing in memory may access input values stored by operating system 237 via API 202. In a similar manner, API 201 may provide an interface between input locking module 210 and input devices coupled to device 100 at the hardware level.

Embodiments of the present invention may be operable to perform functions in response to commands issued by the user using the native buttons of a device. Native buttons (e.g., native buttons 105, 106, 107) may be programmable buttons configured to execute a particular function when pressed by a user. In this manner, native buttons may be pre-programmed in factory by a manufacturer to provide a set of standardized functions required by a conventional operating system as part of a default configuration. For instance, with reference to the embodiment depicted in FIG. 1, native buttons 105, 106, and 107 may each be individually programmed in factory to perform functions associated with the “home” button, “back” button, and “menu” button, respectively. Furthermore, native buttons may be implemented as capacitive touch buttons, mechanical buttons, virtual buttons, etc. Native buttons may be located alongside the display device of a device (e.g., display device 101) or away from the display device (e.g., on the sides of device 100).

According to one embodiment, input locking module 210 may include the functionality to place device 100 in an “inputs locked” state in which applications may be prevented by input locking module 210 from receiving user input through input devices coupled to device 100 for a period of time. For instance, input locking module 210 may include the functionality to recognize and/or process signals received from various input devices coupled to device 100 (e.g., touch sensor 102, optional input device 103, etc.). According to one embodiment, upon receiving a command from a user to engage device 100 in an inputs locked state (e.g., see “inputs lock command” discussed infra), input locking module 210 may be configured to intercept and/or suspend input signals transmitted from these input devices while an application (e.g., application 236) is executed. In this manner, users may be prevented from interacting with the executed application using input devices coupled to device 100 for the duration of device 100's inputs locked state.

Additionally, embodiments of the present invention may also be configured to prevent applications from receiving input through the native buttons of a device for a period of time. According to one embodiment, upon receiving a command from a user to engage device 100 in an inputs locked state, input locking module 210 may be configured to intercept and/or suspend input signals received through native buttons 105, 106 and/or 107 while an application (e.g., application 236) is executed. In this manner, users may be prevented from interacting with the executed application using native buttons 105, 106 and/or 107 for the duration of device 100's inputs locked state.

Embodiments of the present invention may place a device in an inputs locked state in response to detecting an “inputs lock command” from a user. For instance, in one embodiment, input locking module 210 may be capable of detecting the execution of an inputs lock command in which the user simultaneously presses all of the native buttons of a device at once. Furthermore, in one embodiment, input locking module 210 may include the functionality to detect “long press” button events (e.g., buttons pressed and held for a general period of more than 1 second). For instance, in one embodiment, input locking module 210 may be capable of detecting the execution of an inputs lock command in which the user simultaneously presses all of the native buttons of device 100 for the duration of a “long press” (e.g., native buttons 105, 106 and 107 pressed and held for 3 seconds).

Embodiments of the present invention may also be operable to remove a device from an inputs locked state in response to detecting a subsequent “unlock” command (“inputs unlock” command) from a user. According to one embodiment, input locking module 210 may include the functionality to analyze signal patterns associated with signals intercepted during an inputs locked state and determine whether these signal patterns are consistent with the performance a valid unlock command. Upon recognition of a valid unlock command, input locking module 210 may proceed to place a device in an unlocked state in which applications residing in memory may resume receiving input through input devices coupled to the device at the hardware level (e.g., standard operation state of device 100). For instance, in response to receiving a valid unlock command from a user, input locking module 210 may be configured to enable application 236 to resume receipt of input signals transmitted from input devices coupled to device 100 (e.g., touch sensor 102, optional input device 103, etc.). Furthermore, according to one embodiment, input locking module 210 may be configured to enable application 236 to resume receipt of input signals transmitted from native buttons 105, 106 and 107 in response to receiving a valid unlock command.

Furthermore, embodiments of the present invention may also be capable removing a device from an inputs locked state in situations where input locking module 210 has not received an unlock command from a user. For instance, according to one embodiment, input locking module 210 may be configured to remove a device from an inputs locked state in response to detecting a device reboot command from a user. Embodiments of the present invention may also be configured to remove a device from an inputs locked state using system timeouts. For instance, in one embodiment, a device may return to an unlocked functional state after specific period of time has elapsed in which the device operated within an inputs locked state. These system timeout periods may be programmed in factory or may be determined by the user during a calibration or setup phase of a device.

Also, according to one embodiment, inputs lock/unlock commands may be stored within memory resident on a device (e.g., memory 135) that is accessible to input locking module 210. As such, commands may be a priori data loaded within memory resident on device 100 in factory or may be determined by the user during a calibration or setup phase of device 100. In one embodiment, the user may issue an unlock command using the same command used to issue the inputs lock command (e.g., simultaneously pressing all of the native buttons of a device for the duration of a “long press”). In one embodiment, the inputs lock and unlock commands may be issued using different commands.

Furthermore embodiments of the present invention may be capable of prompting a user to confirm lock commands issued by a user. According to one embodiment, prompting module 211 may include the functionality to present the user with a confirmatory display prompt via a display device (e.g., display device 101) in response to a detection of an inputs lock/unlock command by input locking module 210. Prompting module 211 may also include the functionality to communicate determinations made by the user to input locking module 210. Accordingly, in response to the determinations received from prompting module 211, input locking module 210 may proceed to place device 100 in either an inputs locked or unlocked state.

For instance, in one embodiment, input locking module 210 may invoke prompting module 211 upon detection of an inputs lock command issued by the user during a device's normal operational state. Accordingly, input locking module 210 may instruct prompting module 211 to prompt the user to confirm the detected inputs lock command via display device 101. If the user affirms the detected the inputs lock command, (e.g., the user selects “yes” when prompted by prompting module 211 via display device 101), prompting module 211 may communicate the affirmative response to input locking module 210 which may lead input locking module 210 to place device 100 in an inputs locked state. Furthermore, in one embodiment, input locking module 210 may also communicate with display device 101 to provide a visual indicator that reflects the placement of device 100 into an inputs locked state (e.g., banner displayed within a region of display device 101). Alternatively, if the user refutes issuance of the detected the inputs lock command, (e.g., the user selects “no” when prompted by prompting module 211 via display device 101), prompting module 211 may communicate the response to input locking module 210 which may lead input locking module 210 to allow device 100 to remain in its current functional state.

Also, according to one embodiment, input locking module 210 may invoke prompting module 211 upon detection of an unlock command issued by the user during an inputs locked state. Accordingly, prompting module 211 may prompt the user to confirm the detected unlock command. If the user affirms the detected the unlock command, prompting module 211 may communicate the affirmative response to input locking module 210 which may lead input locking module 210 to place device 100 in an unlocked state. Conversely, if the user refutes issuance of the detected the unlock command, (e.g., the user selects “no” when prompted by prompting module 211 via display device 101), prompting module 211 may communicate the response to input locking module 210 which may lead input locking module 210 to allow device 100 to remain in its current inputs locked state.

With further reference to FIG. 1, touch sensor 102 may include the functionality to detect the occurrence of touch events performed by one or more users using touch sensor 102 and/or display device 101 and communicate inputs received to components of device 100 for further processing. For instance, according to one embodiment, touch sensor 102 may be a capacitive touch device coupled with display device 101 that is capable of providing sampling point data associated with touch events performed using touch sensor 102 and/or display device 101. Sampling point data may provide locational information (e.g., touch event coordinates) regarding where contact is made with touch sensor 102 and/or display device 101.

Furthermore, touch events may be provided by sources such as fingertips or by instruments capable of providing contact with a touch surface (e.g., a stylus). Touch sensor 102 may also include the functionality to capture multiple touch events simultaneously. Additionally, touch sensor 102 may also include the functionality to transmit touch event data received to input locking module 210. In one embodiment, touch event data may include sampling point data, pressure data associated with the touch events performed, as well as timestamp data providing the time at which the touch events occurred. Furthermore, touch sensor 102 may include the functionality to transmit data received to input locking module 210 via system APIs (e.g., API 201).

Display device 101 may include the functionality to display output. Examples of display device 101 may include, but are not limited to, a liquid crystal display (LCD), a plasma display, cathode ray tube (CRT) monitor, etc. In one embodiment of the present invention, the functionality of touch sensor 102 and display device 101 may be included in the same touch-sensitive device (e.g., electronic touch screen display device). Additionally, in one embodiment, processor 125 may include the functionality to process instructions from applications (e.g., application 236) and to read data received from touch sensor 102 and/or optional input devices coupled to device 100 (e.g., optional input device 103). Furthermore, processor 125 may store processed data in memory resident on device 100 (e.g., memory 135) for further processing via internal communications bus (e.g., internal bus 105). Optional input device 103 may include, but is not limited to, a keyboard, a mouse, a joystick, a microphone, etc. Furthermore, interface 110 allows device 100 to communicate with other computer devices via an electronic communications network, including wired and/or wireless communication and including the Internet.

FIG. 2A provides a flow chart depicting an exemplary input locking process in accordance with embodiments of the present invention.

At step 405, the device operates in a state in which applications are capable of receiving user input through input devices coupled to the device as well as from the native buttons of the device.

At step 410, the user issues an “inputs lock” command using the native buttons of the device.

At step 415, the input locking module detects the inputs lock command issued by the user at step 410 and then prompts the user to confirm whether the detected command is valid.

At step 420 a determination is made as to whether the inputs lock command issued at step 410 valid. If the inputs lock command is determined to be valid, then the input locking module intercepts and/or suspends an application's receipt of user input transmitted through input devices coupled to the device as well as from the native buttons of the device, as detailed in step 425. If the inputs lock command is determined to not be valid, then the device operates in a state in which applications are capable of receiving user input through input devices coupled to the device as well as from the native buttons of the device, as detailed in step 405.

At step 425, the lock command issued at step 410 is determined to be valid and, therefore, the input locking module intercepts and/or suspends an application's receipt of user input transmitted through input devices coupled to the device as well as from the native buttons of the device. At step 425, applications are allowed to execute, and simply ignore any user input as outlined above.

FIG. 2B provides a flow chart depicting an exemplary input unlocking process in accordance with embodiments of the present invention.

At step 505, the device operates in a state in which the input locking module intercepts and/or suspends an application's receipt of user input transmitted through input devices coupled to the device as well as from the native buttons of the device.

At step 510, the user issues an “inputs unlock” command using the native buttons of the device.

At step 515, the input locking module detects the inputs unlock command issued by the user at step 510 and then prompts the user to confirm whether the detected command is valid.

At step 520 a determination is made as to whether the inputs unlock command issued at step 510 valid. If the inputs unlock command is determined to be valid, then the input locking module enables the device to operate in a state in which applications are capable of receiving user input through input devices coupled to the device as well as from the native buttons of the device, as detailed in step 525. If the inputs unlock command is determined to not be valid, then the device operates in a state in which the input locking module intercepts and/or suspends an application's receipt of user input transmitted through input devices coupled to the device as well as from the native buttons of the device, as detailed in step 505.

At step 525, the inputs unlock command issued at step 510 is determined to be valid and, therefore, the input locking module enables the device to operate in a state in which applications are capable of receiving user input through input devices coupled to the device as well as from the native buttons of the device.

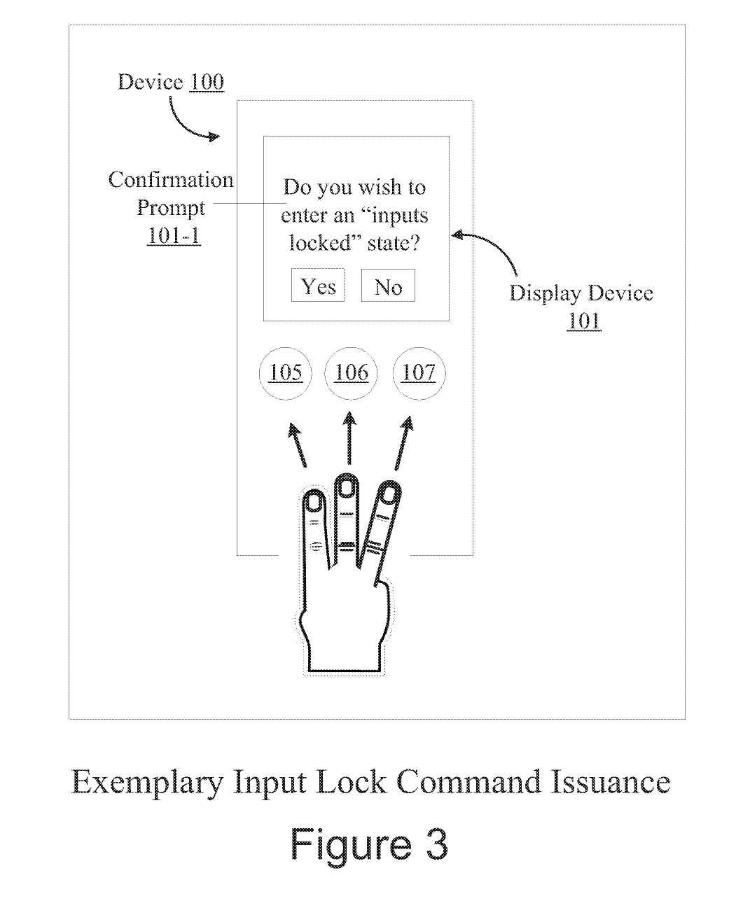

FIG. 3 depicts an embodiment in which an inputs lock command is received and processed by device 100 in accordance with embodiments of the present invention. As illustrated in FIG. 3, a user may issue an “inputs lock” command using the native buttons of device 100 (e.g., buttons 105, 106 and 107). Native button 105 may be configured to be the “home” button which enables the user to return to a main screen view or “home” screen. Native button 106 may be configured to be the “Back” button which enables the user to return to a previous display viewed by the user. Also, native button 107 may configured to be the “Menu” button which enables the user to select a particular view from a list of pre-defined views. As illustrated in FIG. 3, native buttons 105, 106 and 107 may be positioned below the display device 101 of device 100 and implemented as capacitive touch buttons or mechanical buttons.

As illustrated by the embodiment depicted in FIG. 3, the user may issue an inputs lock command by simultaneously pressing the native buttons of device 100 (e.g., buttons 105, 106 and 107). In one embodiment, the user may continue pressing these buttons for the duration of a “long press” (e.g., longer than 3 seconds). Upon recognition of this command, input locking module 210 may communicate with prompting module 211 (see FIG. 1) to display confirmation prompt 101-1, which prompts the user to confirm the detected inputs lock command. If the user selects an affirmative option (“yes”) to proceed with the performance, input locking module 210 may then begin immediate execution of input locking operations. However, if the user declines to proceed with the performance, input locking module 210 may allow device 100 to continue operating in its current state.

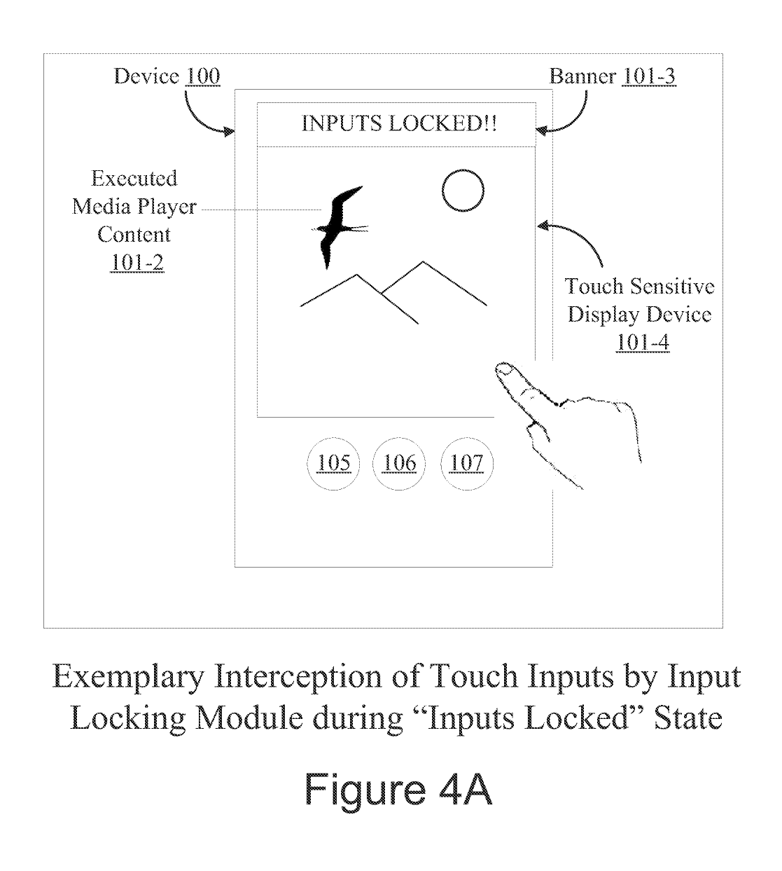

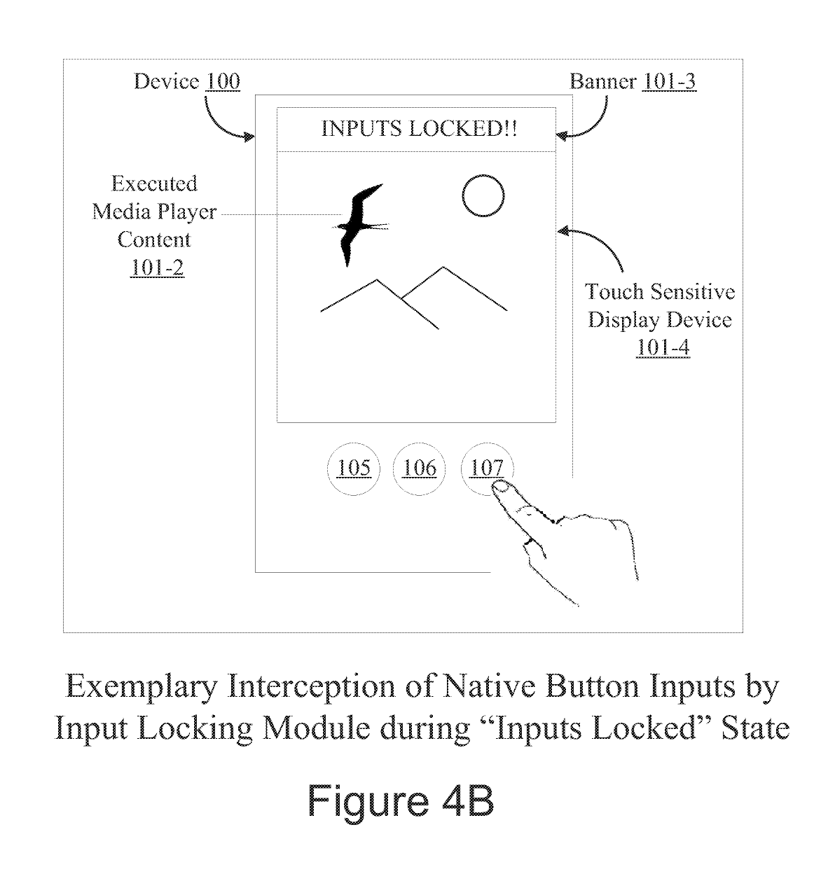

FIG. 4A depicts a use case in which device 100 is placed in an inputs locked state in accordance with embodiments of the present invention. During an inputs locked state, as illustrated by the embodiment depicted in FIG. 4A, input locking module 210 may communicate with touch sensitive display device 101-4 to display banner 101-3, which serves as a visual indicator reflecting device 100's current placement into an inputs locked state. Also, media player content 101-2 illustrates how a media player application may execute and display video content via touch-sensitive display device 101-4 during an inputs locked state. During a standard operational state (e.g., unlocked state), device 100 may normally communicate the touch event performed by the user (e.g., contact made with touch-sensitive display device 101-4 by user's finger) to the media player application. Furthermore, in response to this touch event, the media player application may normally provide a corresponding programmed response, such as displaying standard video control features (e.g., play, pause, stop, etc.).

However, given the current inputs locked state of device 100, the touch event provided by the user may be intercepted by input locking module 210. Also, the input provided by the touch event may be suspended by input locking module 210, which may lead to the standard video control features not being displayed to the user. In this manner, the user may be prevented from engaging device 100 through touch events captured via touch-sensitive display device 101-4 for the duration of the inputs locked state (e.g., until input locking module 210 receives an unlock command). As such, media player content 101-2 may be displayed in a manner which prevents the user from providing inadvertent touch inputs during its execution.

FIG. 4B depicts another use case in which device 100 is placed in an inputs locked state in accordance with embodiments of the present invention. Similar to the embodiment depicted in FIG. 4A, device 100 may be placed in an inputs locked state in which a media player application may be executed by the user to display video content via touch-sensitive display device 101-4. During a standard operational state (e.g., unlocked state), device 100 may normally communicate the button event generated by the user pressing down on native button 107, as illustrated in FIG. 4B, to the operating system of device 100. Furthermore, in response to this button event, the operating system of device 100 may normally pause or terminate the user's session with the media player application and immediately perform a corresponding programmed response associated with native button 107, such as returning the user to the “home” screen.

However, given the current inputs locked state of device 100, the button press event associated with native button 107 may be intercepted by input locking module 210. Additionally, the button press event associated with native button 107 may be suspended by input locking module 210, which may result in the user continuing his or her session with the media player application uninterrupted. In this manner, the user may be prevented from engaging device 100 through the native buttons of device 100 (e.g., buttons 105, 106 and/or 107) for the duration of inputs locked state (e.g., until input locking module 210 receives an unlock command). As such, media player content 101-2 may be displayed in a manner which prevents the user from providing inadvertent native button input during its execution.

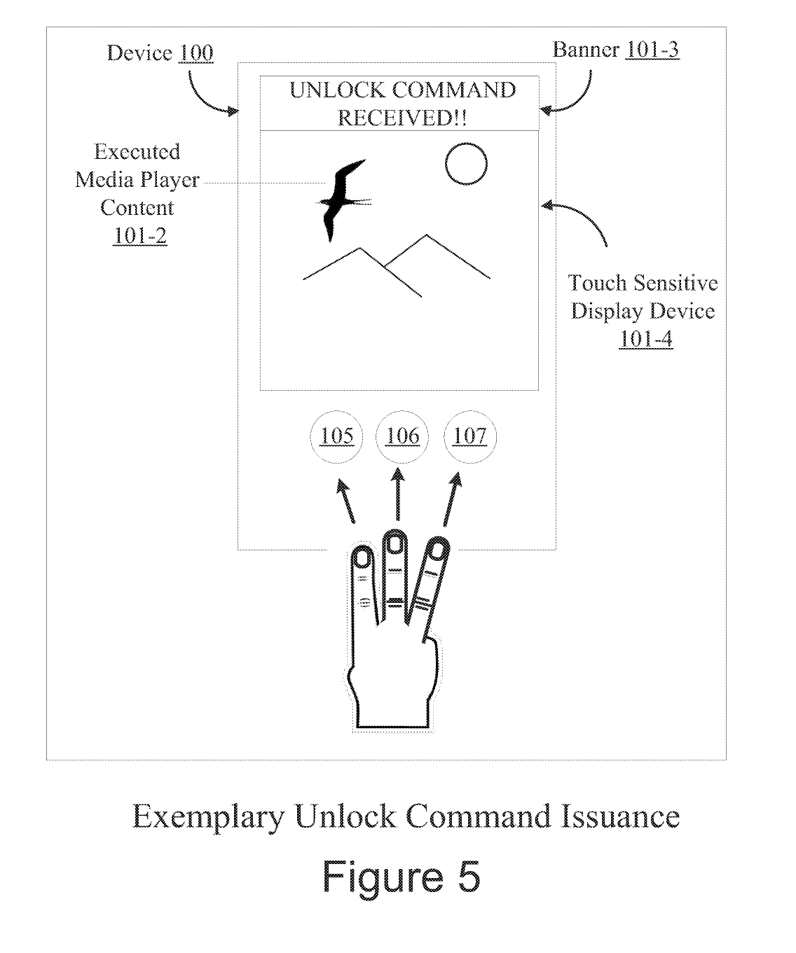

FIG. 5 depicts an embodiment in which an unlock command is received and processed by device 100 in accordance with embodiments of the present invention. As illustrated in FIG. 5, a user may issue an unlock command using the native buttons (e.g., 105, 106 and 107) of device 100. An unlock command may be performed by a user for purposes of allowing applications to resume receiving user input from input devices coupled to device 100 (e.g., touch-sensitive display device 101-4) as well as the native buttons of device 100 (e.g., buttons 105, 106 and/or 107). As illustrated by the embodiment depicted in FIG. 5, the user may issue an unlock command using the same command used to issue the inputs lock command (e.g., simultaneously pressing native buttons 105, 106 and 107 for the duration of a “long press”). Furthermore, as illustrated in FIG. 5, input locking module 210 may communicate with touch sensitive display device 101-4 to display banner 101-3, which serves as a visual indicator reflecting device 100's removal from an inputs locked state.

In one embodiment, upon recognition of the unlock command, input locking module 210 may communicate with prompting module 211 to display a confirmation prompt which prompts the user to confirm the detected unlock command (e.g., similar to the embodiment depicted in FIG. 3). If the user selects an affirmative option (“yes”) to proceed with the performance, input locking module 210 may then begin immediate execution of unlocking operations. However, if the user declines, input locking module 210 may allow device 100 to continue operating within the current inputs locked state.

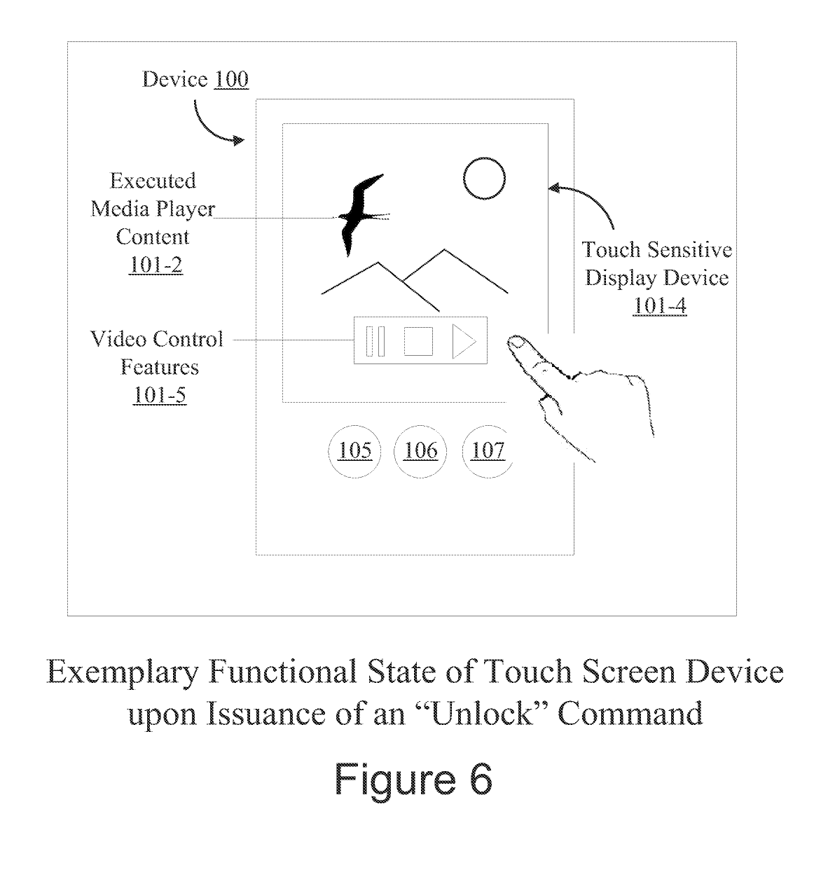

FIG. 6 depicts an embodiment in which device 100 is removed from an inputs locked state in accordance with embodiments of the present invention. As illustrated by the embodiment depicted in FIG. 6, upon receipt of a subsequent unlock command from a user, input locking module 210 may remove device 100 from an inputs locked state and enable device 100 to resume detecting touch events captured through touch-sensitive display device 101-4 and/or receiving input through the native buttons of device 100 (e.g., native buttons 105, 106 and/or 107). Accordingly, user input received via touch-sensitive display device 101-4 and/or the native buttons of device 100 may be processed by the components of device 100. For instance, as illustrated in FIG. 6, standard video control features may now be displayed via touch-sensitive display device 101-4 in response to the touch events provided by the user. In this manner, the user may be no longer prevented from engaging device 100 using touch-sensitive display device 101-4 for the duration of its current state (e.g., until input locking module 210 receives another inputs lock command). As such, video content may be displayed in a standard operational manner.

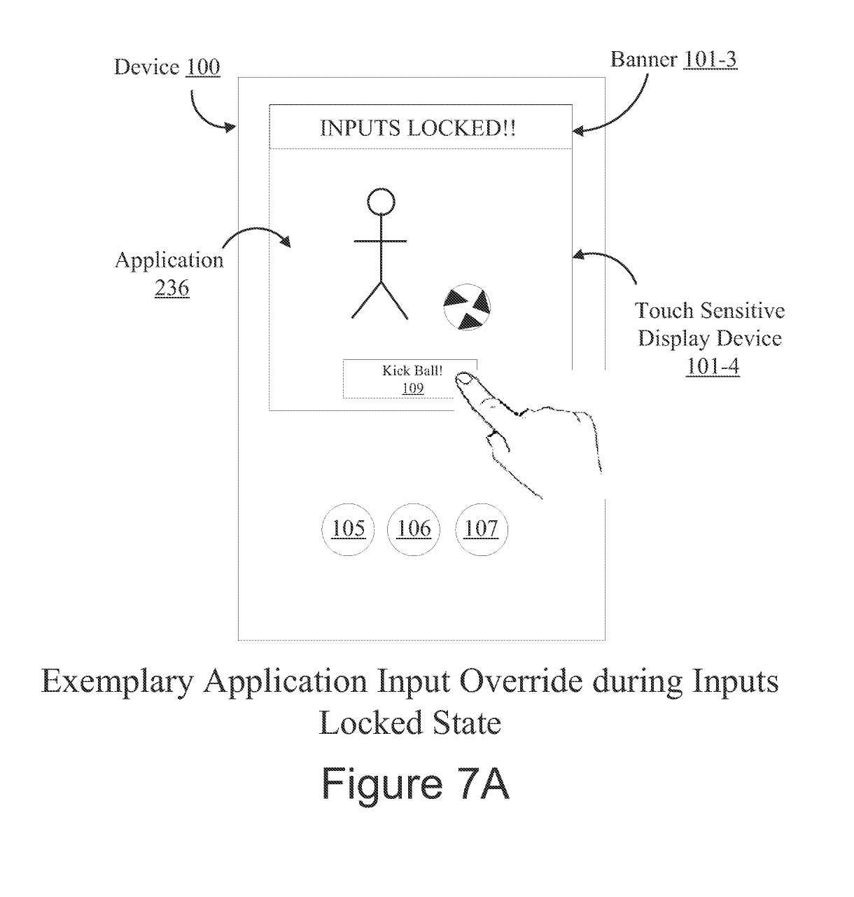

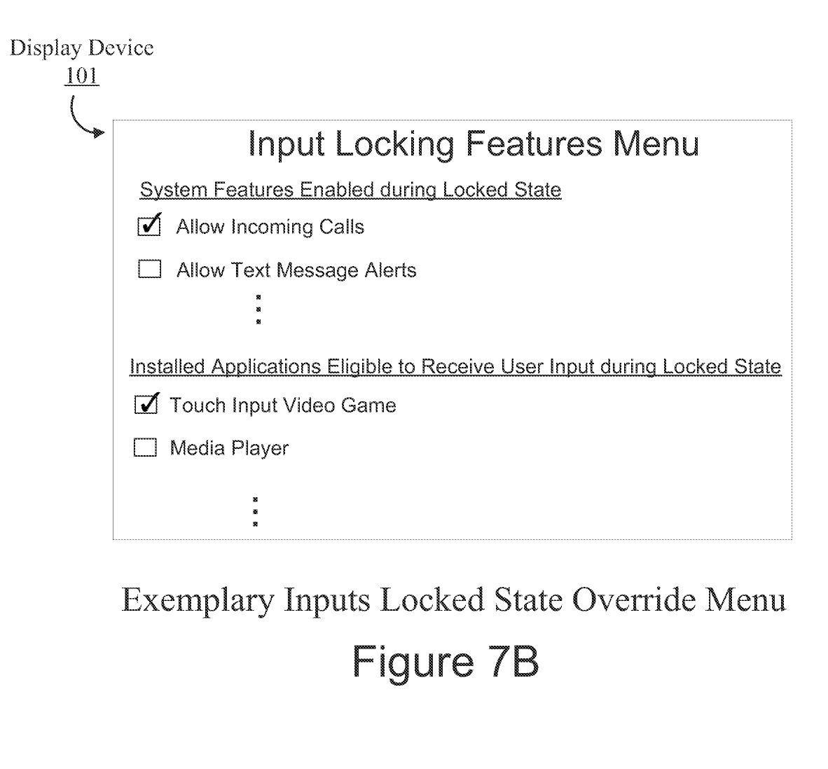

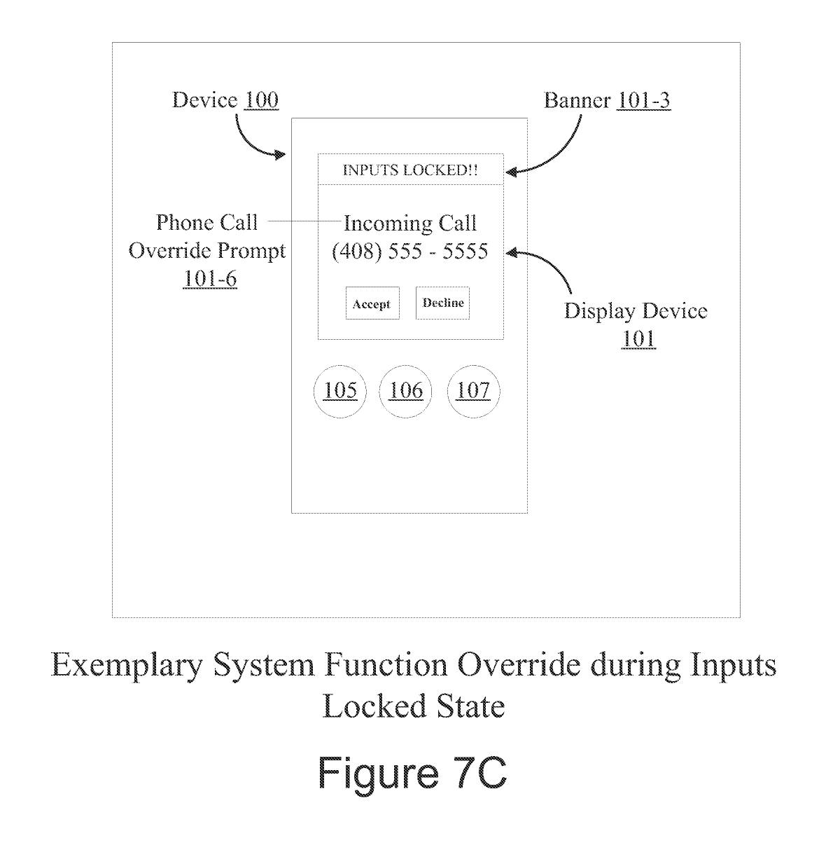

FIG. 7A depicts a functional state in which an application requiring continuous interaction with a user may be configured to override a device's inputs locked state in accordance with embodiments of the present invention. As such, the touch sensitive features of an application may be available to the user while the device continues to operate within an inputs locked state. Application 236 may be a video game that requires active user interaction through user input provided via touch-sensitive display device 101-4. As such, input locking module 210 may be configured to provide an API for sections of touch-sensitive display device 101-4 that may provide holes or active touch regions for application 236 to utilize while the remainder of touch sensitive display device 101-4 remains locked. As illustrated in FIG. 7A, using the API information provided by input locking module 210, application 236 may be able to the position touch sensitive buttons/controls of the application (e.g., “kick ball” button 109) to lay on top (or underneath) of the holes made available by input locking module 210.

FIG. 7B depicts an exemplary on-screen menu selection process in which a user may select certain system functions and/or applications that may operate in a standard manner while a device is placed in an inputs locked state in accordance with embodiments of the present invention. As illustrated by the embodiment depicted in FIG. 7B, a user may be able to make menu selections using a GUI displayed within display device 101 which instructs input locking module 210 to allow certain system functions to execute as though the device was operating in an unlocked state when device 100 is actually placed within an inputs locked state. Additionally, a user may also use a GUI to allow certain applications to continue to receive user input during an inputs locked state. For instance, in the embodiment depicted in FIG. 7B, a user may make menu selections (e.g., placing check marks next to the option) which allow device 100 to continue receiving phone calls or allow users to interact with a video game thorough receipt of touch inputs. In a similar manner, the user may make selections (e.g., not placing check marks next to the option) which instruct device 100 to not display text message alerts or prevent users from interacting with a media player application capable of receiving user inputs during a standard operational state (e.g., an unlocked state).

FIG. 7C depicts a functional state in which certain system functions may override a device's inputs locked state based on determinations made by the user in accordance with embodiments of the present invention. Based on determinations made by the user (e.g., using the menu selection process described in FIG. 7B), input locking module 210 may be configured to allow device 100, which may be a cellular phone, to prompt the user to accept an incoming phone call (e.g., phone call override prompt 101-6) while device 100 remains locked. As such, input locking module 210 may be capable of performing input locking operations while permitting users to engage the standard features associated with device 100.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system.

These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of interacting with a mobile device, said method comprising:
detecting an initial command from a user, wherein said initial command is issued using programmable buttons native to said mobile device;
intercepting input device signals transmitted from an input device coupled to said mobile device during execution of an application responsive to said initial command, wherein said intercepting disables receipt of said input device signals to applications executing on said mobile device; and
enabling receipt of said input device signals by said applications responsive to detecting a subsequent command from said user, wherein said subsequent command is issued using said programmable buttons.

2. The method as described in claim 1, wherein said detecting further comprises prompting said user using a visual display prompt to confirm said initial command.

3. The method as described in claim 1, wherein said intercepting further comprises intercepting button input signals transmitted from said programmable buttons.

4. The method as described in claim 1, wherein said programmable buttons comprise: a home button, a back button and a menu button.

5. The method as described in claim 1, wherein said input device is a touch sensitive input device.

6. The method as described in claim 1, wherein said programmable buttons are capacitive touch buttons.

7. The method of locking a mobile device as described in claim 1, wherein said programmable buttons are mechanical buttons.

8. A system for locking a mobile device, said system comprising:
a detection module operable to detect an initial command from a user, wherein said initial command is issued using programmable buttons of said mobile device, wherein said detection module is operable to detect a subsequent command from said user, wherein said subsequent command is issued using said programmable buttons;
a locking module operable to intercept input device signals transmitted from an input device coupled to said mobile device during execution of an application responsive to said initial command, wherein said locking module is operable to enable receipt of said input device signals responsive to a detection of said subsequent command;
a sensor operable to receive touch input from a user; and
an electronic visual display source coupled adjacent to said sensor.

9. The system for locking a mobile device as described in claim 8, further comprising a prompting module operable to prompt said user using a visual display prompt to confirm said initial command.

10. The system for locking a mobile device as described in claim 8, wherein said locking module is further operable to intercept button input signals transmitted from said programmable buttons.

11. The system for locking a mobile device as described in claim 8, wherein said locking module is further operable to suspend receipt of said input device signals by applications configured to accept said input device signals.

12. The system for locking a mobile device as described in claim 8, wherein said initial command and said subsequent command are invoked by a same user interaction.

13. The system for locking a mobile device as described in claim 8, wherein said programmable buttons are capacitive touch buttons.

14. The system for locking a mobile device as described in claim 8, wherein said programmable buttons are mechanical buttons.

15. A method of locking a mobile device, said method comprising:
detecting an initial command from a user, wherein said initial command is issued using programmable buttons native to said mobile device;
intercepting and suspending input device signals transmitted from an input device coupled to said mobile device during execution of an application responsive to said initial command; and
enabling receipt of said input device signals responsive to detecting a subsequent command from said user, wherein said subsequent command is issued using said programmable buttons.

16. The method of locking a mobile device as described in claim 15, wherein said detecting further comprises prompting said user using a visual display prompt to confirm said initial command.

17. The method of locking a mobile device as described in claim 15, wherein said intercepting and suspending further comprises intercepting and suspending button input signals transmitted from said programmable buttons.

18. The method of locking a mobile device as described in claim 15, wherein said initial command and said subsequent command are invoked by a same user interaction.

19. The method of locking a mobile device as described in claim 15, wherein said programmable buttons are capacitive touch buttons.

20. The method of locking a mobile device as described in claim 15, wherein said programmable buttons are mechanical buttons and wherein said programmable buttons comprise: a home button, a back button and a menu button.
